(19) United States
(12) Patent Application Publication
(10) Pub. No.: US 2019/0204806 A1
(43) Pub. Date: Jul. 4, 2019

(54) METHOD AND DEVICE FOR SYNCHRONOUSLY OPTIMIZING EFFICIENCY AND ENERGY CONSUMPTION OF PROCESSING MACHINE

(71) Applicant: Chung Yuan Christian University, Taoyuan City (TW)

(72) Inventors: Shih-Ming WANG, Taoyuan City (TW); Chun-Yi LEE, Taoyuan City (TW)

(21) Appl. No.: 15/994,876

(22) Filed: May 31, 2018

(30) Foreign Application Priority Data
Dec. 29, 2017 (TW) 106146366

(51) Int. Cl. G05B 19/4063; G05B 19/401; G06Q 50/06; H02J 3/12

(52) U.S. Cl. CPC G05B 19/4063; G05B 19/401; H02J 2003/003; H02J 3/12; G05B 2219/34306; G06Q 50/06

(57) ABSTRACT

A method for synchronously optimizing efficiency and energy consumption of a processing machine includes the following steps. A processing parameter and power consumption information of a motor of the processing machine are obtained to establish a characteristic curve of the processing parameter and the power consumption information. A coupling model of the processing parameter and an electricity consumption is established by using a curve fitting method according to the characteristic curve. A processing chipping instruction of the motor, a unit electricity and a processing time cost are obtained. A processing time, an electricity cost and a comprehensive cost of the processing machine are calculated according to the processing chipping instruction of the motor, the unit electricity, the processing time cost and the coupling model to optimize the processing machine.

### CROSS REFERENCE TO RELATED APPLICATION

This application claims the priority benefit of Taiwan Patent Application Serial Number 106146366, filed on Dec. 29, 2017, the full disclosure of which is incorporated herein by reference.

### BACKGROUND

### Technical Field

This present disclosure generally relates to a method and a device for optimizing and, more particularly, to a method and a device for synchronously optimizing efficiency and energy consumption of a processing machine.

### Related Art

In general, the machining is one of the most extensive and basic manufacturing processes for products or components, wherein the computer numerical control (CNC) machine is the main precision manufacturing equipment. The CNC machine completes the processing of the workpiece through the power consumption, wherein the amount of the processing thereof is large and the processing time thereof is long, so that the total energy consumption is huge. Therefore, in the past, when the companies seek to the improvement for reducing the production costs, the main focus is to shorten the processing time, thereby enhancing the machine operating rate and productivity.

However, with the crisis of energy shortage and the worsening of energy price, it is desirous for the various manufacturers to study to shorten the processing time and reduce the cost of energy (electricity) at the same time.

### SUMMARY

The present disclosure provides a method and a device for synchronously optimizing efficiency and energy consumption of a processing machine, thereby effectively improving the processing efficiency and reducing the power consumption, such that the factory may achieve the effect of energy saving and carbon reduction and increase the production efficiency.

The present disclosure provides a method for synchronously optimizing efficiency and energy consumption of a processing machine, which includes the following steps. A processing parameter and power consumption information of a motor of the processing machine is obtained to establish a characteristic curve of the processing parameter and the power consumption information. A coupling model of the processing parameter and an electricity consumption are established by using a curve fitting method according to the characteristic curve. A processing chipping instruction of the motor, a unit electricity and a processing time cost are obtained. A processing time, an electricity cost and a comprehensive cost of the processing machine are calculated according to the processing chipping instruction of the motor, the unit electricity, the processing time cost and the coupling model, so as to optimize the processing machine.

The present disclosure provides a device for synchronously optimizing efficiency and energy consumption of a processing machine, which includes an establishing module, an obtaining module and a processing module. The establishing module obtains a processing parameter and power consumption information of a motor of the processing machine to establish a characteristic curve of the processing parameter and the power consumption information and establishes a coupling model of the processing parameter and an electricity consumption by using a curve fitting method according to the characteristic curve. The obtaining module obtains a processing chipping instruction of the motor, a unit electricity and a processing time cost. The processing module is coupled to the establishing module and the obtaining module and calculates a processing time, an electricity cost and a comprehensive cost of the processing machine according to the processing chipping instruction of the motor, the unit electricity, the processing time cost and the coupling model, so as to optimize the processing machine.

According to the method and the device for synchronously optimizing efficiency and energy consumption of the processing machine disclosed by the present disclosure, a processing parameter and power consumption information of a motor of the processing machine is obtained to establish a characteristic curve of the processing parameter and the power consumption information. A coupling model of the processing parameter and an electricity consumption are established by using a curve fitting method according to the characteristic curve. A processing chipping instruction of the motor, a unit electricity and a processing time cost are obtained. A processing time, an electricity cost and a comprehensive cost of the processing machine are calculated according to the processing chipping instruction of the motor, the unit electricity, the processing time cost and the coupling model, so as to optimize the processing machine. Therefore, without affecting the processing accuracy, it may effectively improve the processing efficiency and reduce the power consumption, such that the factory may achieve the effect of energy saving and carbon reduction and increase the production efficiency.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a schematic view of a device for synchronously optimizing efficiency and energy consumption of a processing machine according to an embodiment of the present disclosure;

FIG. 2 shows a flowchart of a method for synchronously optimizing efficiency and energy consumption of a processing machine according to an embodiment of the present disclosure; and

FIG. 3 shows a schematic view of a method for synchronously optimizing efficiency and energy consumption of a processing machine according to another embodiment of the present disclosure.

### DETAILED DESCRIPTION OF THE EMBODIMENTS

The present disclosure will now be described more fully hereinafter with reference to the accompanying drawings, in which exemplary embodiments of the invention are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect. Additionally the term “couple” or “connect” covers any direct or indirect electrically coupling means. Therefore when one device is electrically connected to another device in the context, that connection may be through a direct electrical connection, or through an indirect electrical connection via other devices and connections. The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals is used to refer to the same or similar elements throughout.

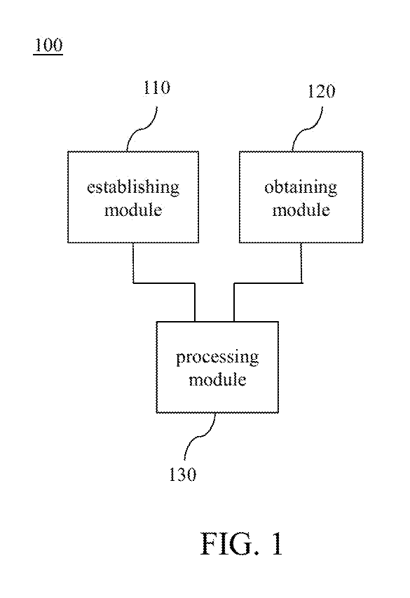

FIG. 1 shows a schematic view of a device for synchronously optimizing efficiency and energy consumption of a processing machine. The device for synchronously optimizing efficiency and energy consumption of the processing machine 100 includes an establishing module 110, an obtaining module 120 and a processing module 130.

The establishing module 110 obtains a processing parameter and power consumption information of a motor of the processing machine to establish a characteristic curve of the processing parameter and the power consumption information. In the embodiment, the motor includes, for example, a spindle motor and a three-axis servo motor. The processing parameter comprises a spindle motor speed and a servo feed speed.

Further, before the processing parameter and the power consumption information of the motor of the processing machine are obtained, it requires different processing parameters for the motor to observe the power consumption of the motor to obtain the relationship between the performance and the power consumption of the motor. Assuming that the spindle motor speed sets 500, 1000, 2000, 3000 RPM, respectively, a power consumption measurement is performed for the spindle motor under these spindle motor speed, so as to obtain the spindle motor speeds and the corresponding power consumption information of the spindle motor. The establishing module 110 establishes the characteristic curve of the spindle motor speed and the power consumption information according to the obtained spindle motor speed and the corresponding power consumption information.

Similarly, assuming that the servo feed speed sets 200, 500, 1000, 1500, 2000, 2500, 3000, 3500, 4000, 4500, 5000, 5500, 6000 mm/min, respectively, and a power consumption measurement is performed for the three-axis servo motor under these servo feed speeds, so as to obtain the servo feed speed and the corresponding power consumption information of the three-axis servo motor. The establishing module 110 establishes the characteristic curve of the servo feed speed and the power consumption information according to the obtained servo feed speed and the corresponding power consumption information. Further, the servo feed speed is, for example, expressed as V=R×Pb, wherein R is motor speed (RPM), Pb is ball screw pitch of servo shaft (mm), and V is the servo feed speed.

After establishing the characteristic curve, the establishing module 110 may establish a coupling model of the processing parameter and an electricity consumption by using a curve fitting method according to the characteristic curve. That is, the establishing module 110 establishes a coupling model of the processing parameter (i.e. the spindle motor speed and the servo feed speed) and an electricity consumption by using a curve fitting method according to the above obtained characteristic curve of the spindle motor speed and the power consumption information and the above obtained characteristic curve of the servo feed speed and the power consumption information, so as to perform the subsequent process.

The obtaining module 120 obtains a processing chipping instruction of the motor, a unit electricity and a processing time cost. In the embodiment, the processing chipping instruction of the motor is, for example, NC program code, i.e. G01, G02, G03, etc. The unit electricity is, for example, cost of the processing machine per kilowatt (NTD/degree). The processing time cost is, for example, the unit processing time cost (NTD/hr) of the processing machine multiplied by the processing time (hr).

The processing module 130 is coupled to the establishing module 110 and the obtaining module 120 and calculates a processing time, an electricity cost and a comprehensive cost of the processing machine according to the processing chipping instruction of the motor, the unit electricity, the processing time cost and the coupling model, so as to optimize the processing machine.

That is, the processing module 130 may analyze the processing chipping instruction of the motor, the unit electricity, the processing time cost and the coupling model and calculate the processing time, the electricity cost and the comprehensive cost of the processing machine according to an analysis result, so as to optimize the processing machine. Therefore, without affecting the processing accuracy, the device may effectively improve the processing efficiency and reduces the power consumption, such that the factory may achieve the effect of energy saving and carbon reduction and increase the production efficiency.

In the embodiment, the above electricity cost is, for example, the electricity consumption (KW) multiplied by the processing time (hr) and the unit electricity (NTD/hr), and the comprehensive cost is, for example, the electricity cost added with the processing time cost. The processing efficiency may convert the time cost obtained by saving the time to the processing cost, such as Mcr=Mt×Hr, wherein Mcr is the processing cost saved by increasing the processing efficiency, Mt is the saved processing time (hr), and Hr is processing time cost (NTD/hr). P=I×V and 1 kWh=1000 W*hr may be further used, so as to convert the increasing amount of the power efficiency to the electricity cost saved (=the degree of the saved electricity×electricity cost/degree), wherein P is the power of the power consumption (W), I is motor current (A), V is motor voltage (V). Then, the sum of the processing cost and the electricity cost is the comprehensive benefit of processing and energy saving. The optimization of process needs to be better than the original system, i.e. the goal of collaborative optimization design.

Further, the processing module 130 further receives an adjustment instruction, wherein the adjustment instruction is used for adjusting the processing parameter, the unit electricity, the processing time, the electricity cost and the comprehensive cost. That is, the user may adjust the processing parameter, the unit electricity, the processing time, the electricity cost and the comprehensive cost according to the requirement thereof, and the adjustment instruction of the above content is generated to the processing module 130 through a human-machine interface. Then, the processing module 130 may calculate an updating processing time, an updating electricity cost and an updating comprehensive cost according to the adjustment instruction and the coupling model, so as to optimize the processing machine. Therefore, under the adjustment of the parameter that is expected to be modified by the user, it may effectively improve the processing efficiency and reduces the effect of the power consumption, such that the factory may achieve the effect of energy saving and carbon reduction and increase the production efficiency.

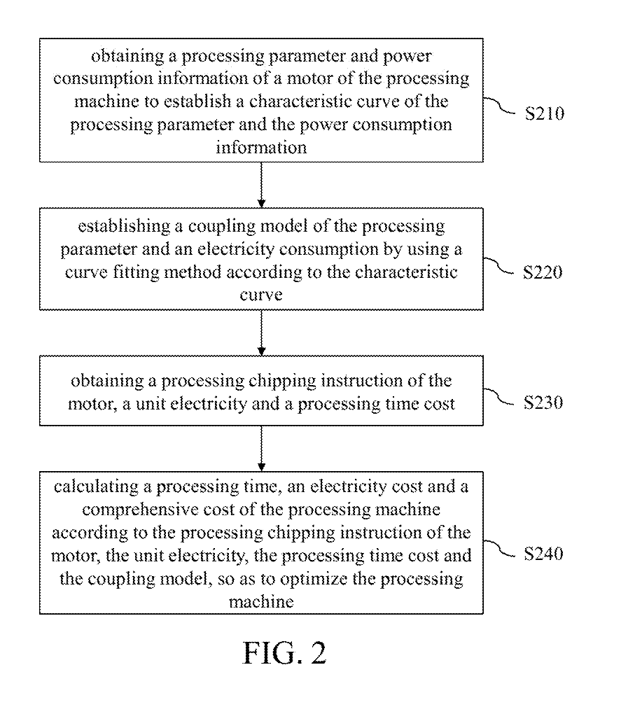

According to the above description of the embodiment, it may sum up a method for synchronously optimizing efficiency and energy consumption of a processing machine. FIG. 2 shows a flowchart of method for synchronously optimizing efficiency and energy consumption of a processing machine according to an embodiment of the present disclosure.

In step S210, the method involves obtaining a processing parameter and power consumption information of a motor of the processing machine to establish a characteristic curve of the processing parameter and the power consumption information. In step S220, the method involves establishing a coupling model of the processing parameter and an electricity consumption by using a curve fitting method according to the characteristic curve. In step S230, the method involves obtaining a processing chipping instruction of the motor, a unit electricity and a processing time cost. In step S240, the method involves calculating a processing time, an electricity cost and a comprehensive cost of the processing machine according to the processing chipping instruction of the motor, the unit electricity, the processing time cost and the coupling model, so as to optimize the processing machine.

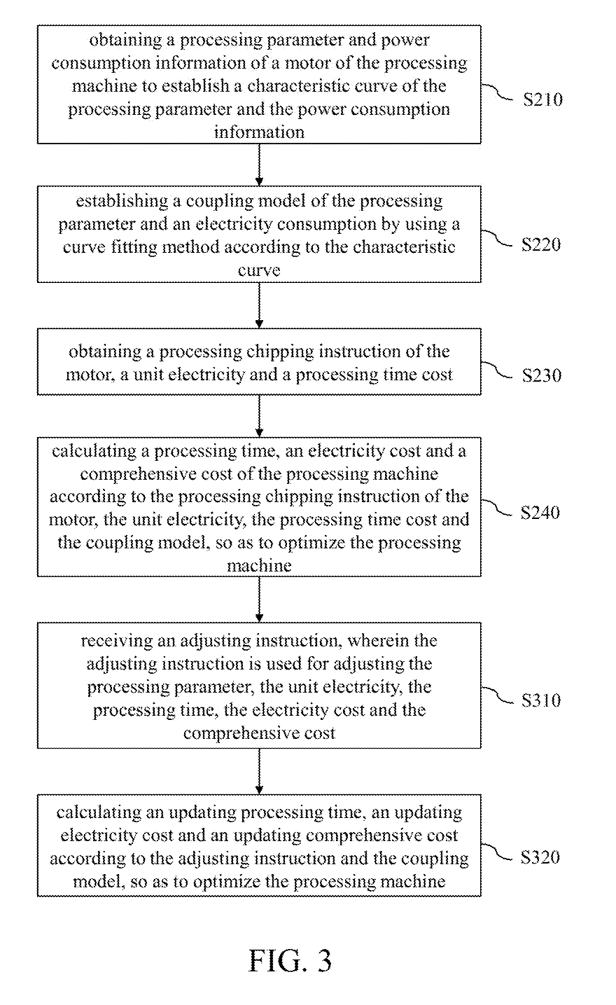

FIG. 3 shows a flowchart of method for synchronously optimizing efficiency and energy consumption of a processing machine according to another embodiment of the present disclosure. In step S210, the method involves obtaining a processing parameter and power consumption information of a motor of the processing machine to establish a characteristic curve of the processing parameter and the power consumption information. In step S220, the method involves establishing a coupling model of the processing parameter and an electricity consumption by using a curve fitting method according to the characteristic curve. In step S230, the method involves obtaining a processing chipping instruction of the motor, a unit electricity and a processing time cost. In step S240, the method involves calculating a processing time, an electricity cost and a comprehensive cost of the processing machine according to the processing chipping instruction of the motor, the unit electricity, the processing time cost and the coupling model to optimize the processing machine.

In step S310, the method involves receiving an adjustment instruction, wherein the adjustment instruction is used for adjusting the processing parameter, the unit electricity, the processing time, the electricity cost and the comprehensive cost. In step S320, the method involves calculating an updating processing time, an updating electricity cost and an updating comprehensive cost according to the adjustment instruction and the coupling model to optimize the processing machine.

As mentioned above, According to the method and the device for synchronously optimizing efficiency and energy consumption of the processing machine disclosed by the embodiments of the present disclosure, a processing parameter and power consumption information of a motor of the processing machine is obtained to establish a characteristic curve of the processing parameter and the power consumption information. A coupling model of the processing parameter and an electricity consumption are established by using a curve fitting method according to the characteristic curve. A processing chipping instruction of the motor, a unit electricity and a processing time cost are obtained. A processing time, an electricity cost and a comprehensive cost of the processing machine are calculated according to the processing chipping instruction of the motor, the unit electricity, the processing time cost and the coupling model, so as to optimize the processing machine. Therefore, in the case without affecting the processing accuracy, it may effectively improve the processing efficiency and reduces the power consumption, such that the factory may achieve the effect of energy saving and carbon reduction and increase the production efficiency.

Additionally, an adjustment instruction may be further received, wherein the adjustment instruction is used for adjusting the processing parameter, the unit electricity, the processing time, the electricity cost and the comprehensive cost, and an updating processing time, an updating electricity cost and an updating comprehensive cost are calculated according to the adjustment instruction and the coupling model, so as to optimize the processing machine. Therefore, under the adjustment of the parameter that is expected to be modified by the user, it may effectively improve the processing efficiency and reduces the power consumption, such that the factory may achieve the effect of energy saving and carbon reduction and increase the production efficiency.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method for synchronously optimizing efficiency and energy consumption of a processing machine, comprising:
obtaining a processing parameter and power consumption information of a motor of the processing machine to establish a characteristic curve of the processing parameter and the power consumption information;
establishing a coupling model of the processing parameter and an electricity consumption by using a curve fitting method according to the characteristic curve;
obtaining a processing chipping instruction of the motor, a unit electricity and a processing time cost; and
calculating a processing time, an electricity cost and a comprehensive cost of the processing machine according to the processing chipping instruction of the motor, the unit electricity, the processing time cost and the coupling model to optimize the processing machine.

2. The method for synchronously optimizing efficiency and energy consumption of the processing machine as claimed in claim 1, further comprising:
receiving an adjustment instruction, wherein the adjustment instruction is used for adjusting the processing parameter, the unit electricity, the processing time, the electricity cost and the comprehensive cost; and
calculating an updating processing time, an updating electricity cost and an updating comprehensive cost according to the adjustment instruction and the coupling model, so as to optimize the processing machine.

3. The method for synchronously optimizing efficiency and energy consumption of the processing machine as claimed in claim 1, wherein the motor includes a spindle motor and a three-axis servo motor.

4. The method for synchronously optimizing efficiency and energy consumption of the processing machine as claimed in claim 2, wherein the processing parameter comprises a spindle motor speed and a servo feed speed.

5. The method for synchronously optimizing efficiency and energy consumption of the processing machine as claimed in claim 4, wherein the electricity cost is the electricity consumption multiplied by the processing time and the unit electricity.

6. The method for synchronously optimizing efficiency and energy consumption of the processing machine as claimed in claim 4, wherein the comprehensive cost is the electricity cost added with the processing time cost.

7. A device for synchronously optimizing efficiency and energy consumption of a processing machine, comprising:
an establishing module, for obtaining a processing parameter and power consumption information of a motor of the processing machine to establish a characteristic curve of the processing parameter and the power consumption information and establishing a coupling model of the processing parameter and an electricity consumption by using a curve fitting method according to the characteristic curve;
an obtaining module, for obtaining a processing chipping instruction of the motor, a unit electricity and a processing time cost; and
a processing module, coupled to the establishing module and the obtaining module, for calculating a processing time, an electricity cost and a comprehensive cost of the processing machine according to the processing chipping instruction of the motor, the unit electricity, the processing time cost and the coupling model to optimize the processing machine.

8. The device for synchronously optimizing efficiency and energy consumption of the processing machine as claimed in claim 7, wherein the processing module further receives an adjustment instruction, wherein the adjustment instruction is used for adjusting the processing parameter, the unit electricity, the processing time, the electricity cost and the comprehensive cost; and the processing module calculates an updating processing time, an updating electricity cost and an updating comprehensive cost according to the adjustment instruction and the coupling model to optimize the processing machine.

9. The device for synchronously optimizing efficiency and energy consumption of the processing machine as claimed in claim 7, wherein the motor includes a spindle motor and a three-axis servo motor.

10. The device for synchronously optimizing efficiency and energy consumption of the processing machine as claimed in claim 9, wherein the processing parameter comprises a spindle motor speed and a servo feed speed.

11. The device for synchronously optimizing efficiency and energy consumption of the processing machine as claimed in claim 10, wherein the electricity cost is the electricity consumption multiplied by the processing time and the unit electricity.

12. The device for synchronously optimizing efficiency and energy consumption of the processing machine as claimed in claim 10, wherein the comprehensive cost is the electricity cost added with the processing time cost.
